(19) United States
(12) Patent Application Publication
(10) Pub. No.: US 2026/0138903 A1
(43) Pub. Date: May 21, 2026

(54) SYSTEM AND METHOD FOR REMOVAL OF PHOSPHORUS FROM A WATER SOURCE

(71) Applicant: University of Massachusetts, Westborough, MA (US)

(72) Inventors: Ahmed S. Abouhend, Amherst, MA (US); Lucca B. K. Mancilio, Northampton, MA (US); Caitlyn S. Butler, Northampton, MA (US)

(21) Appl. No.: 19/377,121

(22) Filed: Nov. 3, 2025

Related U.S. Application Data
(60) Provisional application No. 63/722,639, filed on Nov. 20, 2024.

(51) Int. Cl. C02F 3/30; C02F 1/00; C02F 3/00; C02F 3/10; C02F 3/20; C02F 101/10; C02F 103/00

(52) U.S. Cl. CPC C02F 3/308; C02F 1/001; C02F 3/006; C02F 3/108; C02F 3/20; C02F 2101/105; C02F 2103/007

(57) ABSTRACT

A phosphorus removal system includes a biofilm tank including a plurality of biofilm carriers having a biofilm disposed on at least a portion of a surface of each biofilm carrier. The system further includes a phosphorus recovery tank configured to receive a recovered phosphorus stream from the biofilm tank. Advantageously, the aqueous effluent stream that results from the system has a phosphorus concentration that is less than a phosphorus concentration of the inlet aqueous streams. Methods of phosphorus removal and recovery are also provided.

### CROSS REFERENCE TO RELATED APPLICATION

This application claims the benefit of priority to U.S. Application No. 63/722,639, filed on Nov. 20, 2024, the contents of which are incorporated by reference in their entirety herein.

### BACKGROUND

Excess phosphorus in freshwater bodies is a major environmental concern, leading to eutrophication, harmful algal blooms, and degradation of water quality. Traditional methods for removing phosphorus from polluted freshwater bodies include mechanical dredging, pond aeration, the application of aluminum salts (alum), and using lanthanum-modified bentonite clay. Mechanical dredging, which involves removing the unconsolidated sediment layer, is highly effective but extremely disruptive and expensive. Pond aeration, combined with beneficial bacteria, helps decompose organic matter and reduce nutrient accumulation, but it is primarily effective for managing carbon and nitrogen loads and is less effective at addressing phosphorus, which is usually the limiting nutrient for freshwater blooms. Alum, used for over 30 years, can remove phosphorus from the water column and control its release from sediments, but its effectiveness is limited by pH levels, potential toxicity, and the need for repeat applications due to its non-permanent deactivation of phosphorus. Lanthanum-modified bentonite clay, known as Phoslock™, is effective in removing phosphorus across a wide range of pH levels by bonding with phosphorus to form a stable mineral that settles at the bottom of the water body. However, implementing lanthanum requires precise knowledge of water quality and phosphorus levels for accurate dosing, necessitates continuous monitoring, and can be costly, especially for large-scale applications.

All these technologies must be directly introduced into the aquatic ecosystem, which means that the process can be potentially disruptive to the existing aquatic life. The introduction of chemicals or physical alterations can temporarily disturb habitat, stress aquatic organisms, and alter the ecosystem's natural balance. Therefore, while these methods can effectively mitigate phosphorus levels, they also require careful planning and management to minimize negative impacts on the aquatic environment.

Accordingly, there remains a continuing need in the art for improved methods for removing phosphorus from freshwater bodies.

### SUMMARY

Disclosed herein is a method providing water that contains a first concentration of phosphorus; under aerobic conditions, contacting the water with a biofilm comprising microorganisms which remove (e.g., by absorption) phosphorus from the water; after contacting, removing water that has a second concentration of phosphorus that is lower than the initial level of phosphorus; after removing the water, under anaerobic conditions contacting the biofilm with a phosphorus recovery solution comprising a carbon source to cause the microorganisms to release (e.g., desorb) the phosphorus into the phosphorus recovery solution, and after contacting. storing the phosphorus recovery solution. The phosphorous recovery solution can be stored, for example, in a separate vessel and may be recycled for use in later (e.g., repeated) anaerobic stage steps.

Also disclosed is system a for removing phosphorus from water comprising: a first vessel configured to receive water containing phosphorus and to discharge the water after treatment, the vessel containing biofilms comprising microorganisms which absorb phosphorus in aerobic conditions, the vessel having a switchable oxygen source, such that the vessel can operate in aerobic or anaerobic conditions, a phosphorus recovery solution storage vessel and carbon source fluidly connected to the first vessel, to provide a phosphorus recovery solution to the first vessel to cause release of phosphorus from the microorganisms into the phosphorus recovery solution during anaerobic operation of the first vessel.

The above described and other features are exemplified by the following figures and detailed description.

### BRIEF DESCRIPTION OF THE DRAWINGS

The following figures represent exemplary embodiments.

FIG. 1 is a schematic illustration of a system and a method according to an aspect of the present disclosure.

FIG. 2 is an image of an example of a self-aggregated biofilm.

FIGS. 3a and 3b are photographs of examples of carriers for a biofilm.

### DETAILED DESCRIPTION

The present inventors have discovered a biofilm-based technology designed to remove and recover phosphorus from contaminated freshwater bodies, such as ponds and lakes, without disrupting the aquatic ecosystem. This external and onsite treatment approach ensures the preservation of natural water habitats while addressing the critical issues of eutrophication and algal blooms that stem from excess phosphorus in aquatic ecosystems.

One advantage of the disclosed present phosphorus removal system is that, in addition to removing phosphorus from a water body, it can also recover it in a useable form. This recovered phosphorus can be repurposed in various applications, potentially as fertilizers, thereby promoting a circular economy. The modular and scalable design of the system allows it to be customized to various water body sizes and contamination levels, making it adaptable from small ponds to large lakes. The present phosphorus removal system is distinguished by its environmental benefits, preventing the adverse effects of eutrophication, supporting healthier aquatic life, and reducing the environmental impact of human activity. Furthermore, it can offer a cost-effective alternative to traditional phosphorus removal methods, requiring minimal energy and maintenance while providing significant ecological and economic advantages. A significant improvement is therefore provided by the present disclosure.

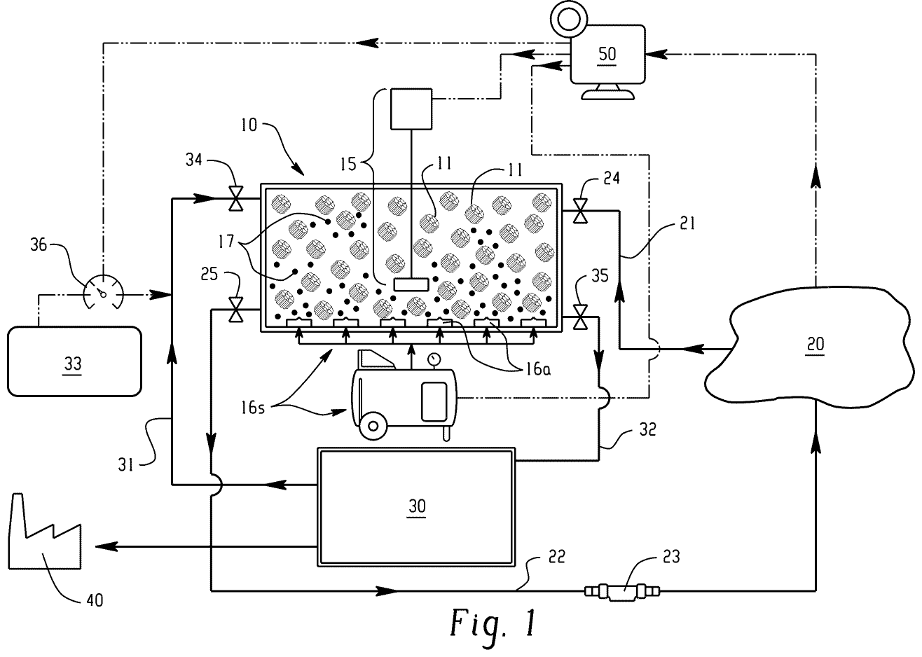

FIG. 1 shows an example of a phosphorus removal system as disclosed herein. Water from a water source 20 to be treated, such as a polluted freshwater body (e.g., pond, or the like), storm water run-off, agricultural water run-off, secondary effluent wastewater, can be transported (e.g., pumped) into a vessel 10, for example, through an inlet conduit 21. The vessel 10 can have any shape that can hold water, for example, cylindrical, rectangular, or cone-bottom. There can be a pump (not shown) and/or a valve 24, located between the body of water 20 and the vessel 10, controlling flow of water into the vessel. The valve 24 can be located for example, where the inlet conduit 21 empties into the vessel 10. Soluble phosphorus in the water can be bound by temporarily incorporating (e.g., absorbing it into a biofilm or by being utilized/assimilated by the microorganisms growing with the biofilm), effectively reducing phosphorus concentrations in the water. The biofilm can be a self-aggregated community of microorganisms forming a macroscopic granular structure such a bioaggregate or biogranule or the biofilm can be a community of microorganisms growing on a surface, nooks or pores of a carrier 11. The biofilms can be formed prior to full activity of the reactor, through a start-up phase that consists in running the system using local sediment or activated sludge as inoculum, for a period between 10 and 30 days. These carriers 11 can be fixed or loose in the vessel 10. For example, the carriers 11 can float in the vessel 10. The treated water can then be returned to the water body 20, for example, though an outlet conduit 22 connected to the vessel 10. In cases where the source (polluted water) is stormwater, agricultural wastewater, or secondary effluent wastewater, the treated water can be safely discharged into natural water streams. There can be a valve 25, located between the body of water 20 and the vessel 10, controlling flow of water out of the vessel. The valve 25 can be located for example, where the vessel 10 connects to the outlet conduit 22 empties into the vessel 10. A filter 23 can be found in the outlet conduit 23 as shown or can be located wherein the vessel 10 empties into the outlet conduit 22 or before the valve 25. Filters 25 and 35 positioned at the vessel's outlet can prevent the loss of loose carriers or self-aggregated biofilm into the conduit, reducing the risk of clogging in valves or conduits and preventing contamination of the water source with microbial biofilm.

In an embodiment (not shown) the system can be run as trickling bed where the water to be treated is trickled or run over the carrier 11. In that embodiment, the carriers are fixed. In this trickling bed structure, the water can be accumulated at the bottom of the vessel 10 before returning to water body, can be recycled to the top of the vessel, or can continuously be returned to the water body.

When the system is run as shown in FIG. 1 as a vessel 10 that holds the water to be treated, the carriers 11 can be fixed or can be allowed to circulate freely within the vessel 10.

In a first step of the method, the capture of phosphorus, and optionally also nitrogen species like ammonia, nitrate, and nitrite, by the biofilm occurs during an aerobic phase (the presence of oxygen or air 17). The system preferably has an oxygen concentration of at least 2.5, at least 3, or at least 4 milligrams of oxygen per liter (mg O₂/L) up to the saturation limit (which is temperature dependent) or up to about 13, up to about 10, up to about 8 mg O₂/L in the bulk liquid. The presence of oxygen supports the growth of phosphorus-utilizing microorganisms within the biofilm. Aeration or oxygenation can be supplied by various methods, including mechanical aeration/oxygenation, overhead mixing, or submerged mixing. Mechanical aeration can be achieved by pumping air or pure oxygen to accelerate the process. For a trickling bed system, oxygen is naturally available from ambient air, with natural draft ventilation as the primary aeration mechanism. In a system as shown in FIG. 1 where the biofilms are submerged in the water, aeration is needed. For example, as shown in FIG. 1 an overhead mixer 15 can be used. As another alternative, (not shown) fully submerged mixers can be used. As yet another alternative, an aeration system 16s comprising aerators 16a can be used. A combination of these agitation devices can be used.

The vessel 10 can be filled and the carriers 11 circulate freely within the vessel 10, keeping the biofilm active and efficient in utilizing phosphorus and other nutrients and breaking down organic matter. These carriers 11 are designed to maximize surface area, enhancing microbial attachment, substrate utilization, and increasing the treatment capacity of the biofilm system.

After the aerobic stage, during which microorganisms in the biofilm accumulate phosphorus, the system can be changed to anaerobic operation by removing the source of oxygen, for example shutting off the aerators while maintain minimal mixing to keep the biofilm suspended. During the anaerobic stage, the biofilm is caused to release the phosphorus into a phosphorus recovery solution. For example, in the vessel 10 holding water as shown in FIG. 1, the treated water is returned to the water body 20 and a phosphorus recovery solution is introduced into the vessel 10. The phosphorus recovery solution can be provided from a storage vessel 30 to the vessel 10 via an inlet conduit 31 such that the biofilm is submerged in the phosphorus recovery solution. Any aeration in the vessel is ceased. The phosphorus recovery solution will include a carbon source material 33. The carbon source material is added to the vessel 10 or the inlet conduit 31. The amount of the carbon source material can be controlled using a meter or valve 36. During the anaerobic stage, the microorganisms release phosphorus into the solution. The phosphorus recovery solution can then be returned to the storage vessel 30 via an outlet conduit 32. Valves 34 and 35 can be found between the storage vessel 30 and the vessel 10 in the inlet conduit 31 and outlet conduit 32, respectively. A filter (not shown) can be used to prevent loss of biofilm and/or carriers 11 from the vessel 10. During the recovery stage in addition to recovering phosphorus in the recovery solution, other valuable components such as calcium, magnesium and/or potassium may be released from the biofilm into the recovery solution.

The phosphorus recovery solution can be reused (recycled from storage vessel 30 to vessel 10 for one or more additional anaerobic cycle steps) until the phosphorus concentration reaches a level where it is desirable to separate the phosphorus from the solution (e.g., higher than 50 milligrams per liter (mg/L)). When the concentration of phosphorus in the phosphorus recover solution in storage vessel 30 is sufficiently high, the phosphorus can be recovered from the solution (e.g., by precipitation) and provided for use in other processes 40.

A control system including a controller 50 may be used to control one or more of: the agitation (e.g., mixer 15 and aeration 16), the dosing of the carbon source 33, pumps and valves to move the water from the water body 20 to the vessel 10 and back to the water body 20, pumps and valves to move the phosphorus recover solution from the storage vessel 30 to the vessel 10 and back to the storage vessel. Compositional analysis one or more of the water body 20 such as concentration of phosphorus, total nitrogen, ammonia, organic matter, and dissolved oxygen level in the water, and the pH of the water, or the like, may be provided to the controller as an input in determining operating conditions such as degree of agitation or aeration, amount of carbon source 33 to add to the vessel 30, or the like.

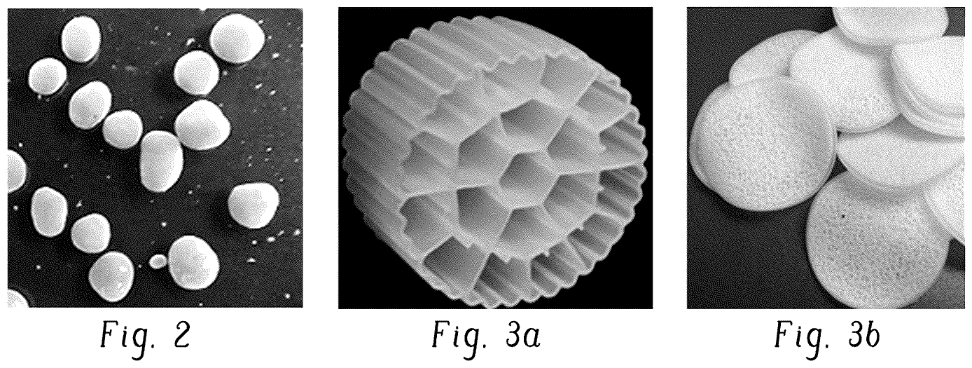

The biofilm can be disposed on (e.g., formed on) a surface of the carriers or can self-aggregate. An example of a self-aggregated biofilm is seen in FIG. 2a. Preferably, the biofilm tank comprises a plurality of biofilm carriers having a biofilm disposed on at least a portion of a surface of each biofilm carrier. The biofilm carrier can generally be of any shape, but it can be desirable to provide a carrier having a high surface area. A high surface area provides more available surface for a biofilm, and thus can enhance phosphorus uptake. Exemplary shapes can include, for example, a honeycomb, spiral, hollow, sponge, network, rod and line shapes. Non-limiting examples of carrier shapes are seen in FIGS. 3a and 3b. The carrier can be formed or rock, ceramic, activated carbon, biochar, zeolite, metal, (e.g., iron, aluminum, copper) or a polymeric material. In an aspect, the carrier is formed from plastic. Exemplary plastic materials can include, but are not limited to, polyethylene, polypropylene, polyester, polyamide, polyvinyl chloride, polyvinylidene chloride, polyvinylidene fluorine and polyurethane. The biofilm can be disposed on the surface of the carrier in amounts of, for example, from 0.02, from 0.03, from 0.04, from 0.05, from 0.06, from 0.07, from 0.08, from 0.09, or from 0.1 up to 0.6, up to 0.55, up to 0.5, up to 0.45, up to 0.4, up to 0.35, up to 0.3, up to 0.25, or up to 0.2 milligrams per square millimeter of carrier surface area. Carrier size can be from a minimum which is larger than outlet dimension, outlet filter, or outlet mesh, for example from 0.1, or from 0.5 up to, for example, 5 cm.

As used herein, the term “biofilm” refers to a population of microorganisms (bacteria, fungi, and/or protozoa, with associated bacteriophages and other viruses) that are aggregated to form a film or gel or that are concentrated at the surface of a carrier. The biofilm preferably includes bacteria (e.g., unicellular, filamentous, or both). The biofilm according to the present disclosure can comprise a plurality of microorganisms which are capable of utilizing and absorbing phosphorus, for example polyphosphate accumulating organisms (PAO), which are not taxonomically limited to a monophyletic group and occur naturally. The polyphosphate accumulating organisms are capable of accumulating phosphorus under aerobic conditions, and as such, capable of removing dissolved phosphorus from the aqueous inlet stream. Specifically, polyphosphate accumulating organisms are capable of taking up phosphorus in excess of its metabolic requirements and accumulating it intracellularly as a phosphate rich species. The polyphosphate accumulating organisms (PAOs) can be any appropriate known PAO, or combination of PAOs. The PAO can be obtained from purified/isolated cultures or can be part of a consortium of organisms enriched from naturally occurring sources, such as activated sludge, wastewater solids, soil and sediments. It can be desirable to grow the biofilm from organisms in the water body source. This can be convenient and/or can avoid introduction of new species into the environment of the water body source. A non-exhaustive list of PAOs considered to be useful for the purposes of the present disclosure can include Candidatus Phosphoribacter, Candidatus Accumulibacter phosphatis, Candidatus Dechloromonas, Candidatus Accumulimonas, and Microlunatus phosphovorus.

The water from the water body 20 can have a concentration phosphorus, for example, of from 0.1, from 0.5, from 1 up to 10, up to 7 or up to 5 milligrams phosphorus/liter of water.

The phosphorus recovery solution can comprise water as the primary component. Other optional ingredients include magnesium sulfate, calcium chloride, sodium carbonate, sodium bicarbonate ethylene diamine tetraacetic acid (EDTA). The optional ingredients can provide pH or chemical buffering capacity to the solution, or just assure the ubiquitous presence of essential nutrients and ions to the biofilms. The optional ingredients, if present can be present in amounts of, for example 1 to 5 milligrams per liter (mg/L) of EDTA, 30 to 60 mg/L of magnesium sulfate, 4 to 20 mg/L or hydrated calcium chloride, 50 to 800 mg/L of sodium bicarbonate.

The carbon source 33 can be, for example, an acetate salt, fumarate, propionate, starch, glucose, methanol, or general fermentates that include volatile fatty acids.

The treated effluent stream (e.g., in outlet conduit 22) has a phosphorus concentration that is less than a phosphorus concentration of the inlet aqueous stream. The method can have a phosphorus removal efficiency (i.e., 100×(initial of phosphorus in the water−final concentration of phosphorus after treatment)/(initial amount of phosphorus in the water) of at least 30%, or at least 35%, or at least 40%, or at least 50%, or at least 60% or at least 70%, or at least 80% or at least 90%. Stated another way, the treated effluent stream can have a phosphorus concentration that is at least 30% less, or at least 35% less, or at least 40% less, or at least 50%, at least 60% less or at least 70% less than an initial phosphorus concentration of the aqueous inlet stream (i.e., sourced from the freshwater body).

During the aerobic treatment stage, the water processed in the vessel can be at a temperature of, for example, from greater than 0, from 5 up to 40, up to 35, up to 30° C. The pH can be for example from 6 to 9. The aerobic stage can continue, for example, for a time of from 0.5, from 1, or from 1.5 hours up to 10, up to 8, or up to 6 hours. An acid or base may be added to the water being processed if the pH is significantly outside such a range.

During the anaerobic stage, the phosphorus recovery solution can be at a temperature of 0, from 5 up to 40, up to 35, up to 30° C. The oxygen in the system is low or zero. For example, dissolved oxygen in the phosphorus recovery solution is less than 0.2, less than 0.1, less than 0.05 and is preferably about 0 mg/L. The pH can be for example from 6 to 9. The anaerobic stage can continue, for example, for a time of from 0.5, from 1 hour up to 4, up to 3 hours. An acid or base may be added to the phosphorus recover solution if the pH is significantly outside such a range. The phosphorus recover solution can be reused (recycled to vessel 10) until the phosphorus concentration reaches a level where it is desirable to capture the phosphorus as discussed herein.

The system can be operated in cycles of 1 hour, 2 hours, 4 hours, or 6 hours, depending on the characteristics of the water and the targeted flow rate. Within each cycle, the aerobic and anaerobic phases will alternate, with the aerobic phase occupying 10%, 20%, 30%, 40%, 50%, 60%, 70%, 80%, or 90% of the total cycle time.

### EXAMPLES

### Example 1

A 5 liter phosphorus removal system according to the present disclosure was operated for one week with a new batch of pond water provide for each aerobic stage and with recycle of the phosphorus recovery solution for each anaerobic stage to treat both low-phosphorus water (e.g., 0.8 milligram per liter) and high-phosphorus water (e.g., 4 milligrams per liter), with a treatment capacity of 20 liters per day. The biofilm was inoculated and cultivated by operating the reactor with activated sludge from a wastewater treatment plant. A carrier was used have the shape of in FIG. 3a and dimensions of 10×7 mm.

The aerobic stage was about 4 hours. The vessel was run in aerobic conditions at a temperature of 25° C., an agitation rate of an overhead mixer of 250 rotations per minute (rpm) and aeration of 5 mg/L as dissolved oxygen level in the bulk liquid for a length of time of 4 hours. The anaerobic stage was 2 hours. The vessel was run in anaerobic conditions at a temperature of 25° C., an agitation rate of an overhead mixer of 250 rotations per minute (rpm) with addition of 100 mg/L COD from sodium acetate. When removing phosphorus from water initially having 0.8 mg phosphorus/liter, an average concentration after treatment was less than 0.3 mg/L (about 63% removal efficiency). When removing phosphorus from water initially having 4 mg phosphorus/liter, an average concentration after treatment was about 2.4 mg/L (about 40% removal efficiency).

### Example 2

Using water with an initial phosphorus concentration of 1.7 mg/L Inlet bulkheads were toward the bottom of the first vessel and valves were located close to the vessel. Influent pH was kept at 7 and recovery solution pH was 7.5. Mixing intensity was at 250 rpm, aeration was at 5 mgDO/L, carbon source dosing was at 1000mg/L. Over 20 days of operation, the system reduced the total phosphorus concentration from 1.7 mg/L to 0.14 mg/L, achieving a 91.6% removal efficiency at its highest performing cycle, well below most environmental permit thresholds.

### Example 3

The system's phosphorus recovery capability was evaluated over a 7-day operational period of cycles of 4 hours of aerobic reaction followed by 2 hours of anaerobic reaction with the phosphorus recovery solution being recycled from the storage vessel to the reaction vessel. The phosphorus concentration in the recovery tank steadily increased, from 0 to a concentration of 44 mg/L.

### Example 4

The phosphorus concentration in the reaction vessel was monitored over a four hour aerobic stage conducted substantially as described above. It was found that phosphorus concentration dropped from 3.6 mg/L to 1.8 mg/L in the first 90 minutes, with the rate of removal slowing substantially after that point.

### Example 5

Three parallel 1-L reactors were operated for 30 days under sequencing batch conditions to evaluate the removal of ammonium and phosphorus from secondary effluent. Effect of carrier geometry was evaluated by developing biofilms on three carrier types: a) Mutag™ biochips as shown in FIG. 3b, b) HDPE carriers as shown in FIG. 3a having dimensions of 10×7 mm, and c) HDPE carriers as shown in FIG. 3 a having dimensions 25×7 mm) each occupying approximately 40 % of the reactor volume. The reactor underwent 4-hour aerobic phase, followed by 2 hour anaerobic phase.

Efficient nitrogen and phosphorus removal was observed across all carrier geometries during the aerobic phase, demonstrating the effectiveness of biofilm-based treatment for post-secondary wastewater polishing.

During the anaerobic phase the reactors were submerged for 2 hours in a recirculated recovery solution which was tap water supplemented with sodium acetate under anaerobic conditions. This phase facilitated the release and subsequent recovery of phosphorus, magnesium, calcium, and potassium from the biofilm matrix. Phosphorus was recovered both as dissolved orthophosphate and as organic or mineralized total phosphorus (TP), confirming the system's dual functionality for nutrient removal and recovery within a single operational cycle.

This disclosure further encompasses the following aspects.
Aspect 1: A method comprising: providing water that contains a first concentration of phosphorus; under aerobic conditions, contacting the water with a biofilm comprising microorganisms which remove phosphorus from the water; after contacting, removing water that has a second concentration of phosphorus that is lower than the initial level of phosphorus; after removing the water, under anaerobic conditions contacting the biofilm with a phosphorus recovery solution comprising a carbon source to cause the microorganisms to release the phosphorus into the phosphorus recovery solution, and after contacting. storing the phosphorus recovery solution.
Aspect 2: The method of Aspect 1 wherein the contacting occurs in an aerated vessel holding the water.
Aspect 3: The method of Aspect 1 wherein the contacting occurs by trickling the water over the biofilm.
Aspect 4: The method of any one of the previous Aspects wherein the biofilm is supported on a carrier.
Aspect 5: The method of Aspect 4 wherein the carrier is a polymeric material having the biofilm thereon.
Aspect 6: The method of any one of the previous Aspects wherein the microorganism comprises bacteria.
Aspect 7: The method of any one of the previous Aspects further comprising repeating steps with a new batch of water in step of providing water that contains a first concentration of phosphorus and recycling of the phosphorus recovery solution increasing the concentration of phosphorus in the phosphorus recovery solution.
Aspect 8: The method of Aspect 7, recovering the phosphorus from phosphorus recovery solution.
Aspect 9: The method of any of previous Aspects, wherein the method has a phosphorus removal efficiency of at least 50%.
Aspect 10: The method of any of previous Aspects wherein one or more of calcium, magnesium, or potassium are also released into the phosphorus recovery solution from the microorganisms.
Aspect 11: The method of any of previous Aspects wherein the water provided in step a) has a first concentration of nitrogen and the water removed in step c) has a second concentration of nitrogen that is lower than the first concentration of nitrogen.
Aspect 12: A system for removing phosphorus from water comprising: a first vessel configured to receive water containing phosphorus and to discharge the water after treatment, the vessel containing biofilms comprising microorganisms which absorb phosphorus in aerobic conditions, the vessel having a switchable oxygen source, such that the vessel can operate in aerobic or anaerobic conditions, and a phosphorus recovery solution storage vessel and carbon source fluidly connected to the first vessel, to provide a phosphorus recovery solution to the first vessel to cause release of phosphorus from the microorganisms into the phosphorus recovery solution during anaerobic operation of the first vessel.
Aspect 13: The phosphorus removal system of Aspect 12, wherein the first vessel has a first inlet fluidly connected to a source of the water containing the phosphorus, a second inlet fluidly connected to the phosphorus solution storage vessel, a first outlet fluidly connected to the phosphorus recovery solution storage vessel, and a second outlet fluidly connected to the filtration unit; and wherein the phosphorus recovery solution storage vessel has an inlet fluidly connected to the first outlet of the first vessel, a first outlet fluidly connected to the first vessel via the second inlet of the first vessel and configured to recirculate the phosphorus recovery solution to the first vessel, and a second outlet configured to remove the phosphorus recovery solution from the phosphorus recovery solution vessel; and wherein the system optionally includes a filter configured to filter an effluent stream from the first vessel.
Aspect 14: The phosphorus removal system of Aspect 12 or 13, wherein the first vessel comprises an agitator.
Aspect 15: The phosphorus removal system of any of Aspects 12 to 14, further comprising a carbon source tank fluidly connected to the first vessel.
Aspect 16: The phosphorus removal system of any of Aspects 12 to 15, comprising an aerator configured to provide aeration to the first vessel.
Aspect 17: The phosphorus removal system of any of Aspects 12 to 16, further comprising a control unit.
Aspect 18: The phosphorus removal system of Aspect 17, wherein the control unit is configured to monitor one or more of: water quality of the source of the water containing the phosphorus, the concentration of phosphorus in the first vessel, or the concentration of phosphorus in the phosphorus recovery solution, and further configured to adjust one or more of aeration of the first vessel, agitation of the first vessel, or a dose of the carbon the first vessel.
Aspect 19: The phosphorus removal system of any of Aspects 12 to 18, wherein the biofilm is supported on a carrier.
Aspect 20: The phosphorus removal system of any of Aspects 12 to 19 wherein the biofilm comprises bacteria.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method comprising:
a) providing water that contains a first concentration of phosphorus,
b) under aerobic conditions, contacting the water with a biofilm comprising microorganisms which remove phosphorus from the water,
c) after contacting, removing water that has a second concentration of phosphorus that is lower than the initial level of phosphorus,
d) after removing the water, under anaerobic conditions, contacting the biofilm with a phosphorus recovery solution comprising a carbon source to cause the microorganisms to release the phosphorus into the phosphorus recovery solution, and
e) after contacting, storing the phosphorus recovery solution.

2. The method of claim 1 wherein the contacting occurs in an aerated vessel holding the water.

3. The method of claim 1 wherein the contacting occurs by trickling the water over the biofilm.

4. The method of claim 1 wherein the biofilm is supported on a carrier.

5. The method of claim 4 wherein the carrier is a polymeric material having the biofilm thereon.

6. The method of claim 1 wherein the microorganism comprises bacteria.

7. The method of claim 1 further comprising repeating steps a)-e) with a new batch of water in step a) and recycling of the phosphorus recovery solution increasing the concentration of phosphorus in the phosphorus recovery solution.

8. The method of claim 7, recovering the phosphorus from phosphorus recovery solution.

9. The method of claim 1, wherein the method has a phosphorus removal efficiency of at least 50%.

10. The method of claim 1 wherein one or more of calcium, magnesium, or potassium are also released into the phosphorus recovery solution from the microorganisms.

11. The method of claim 1 wherein the water provided in step a) has a first concentration of nitrogen and the water removed in step c) has a second concentration of nitrogen that is lower than the first concentration of nitrogen.

12. A system for removing phosphorus from water comprising:
a first vessel configured to receive water containing phosphorus and to discharge the water after treatment, the vessel containing biofilms comprising microorganisms which absorb phosphorus in aerobic conditions, the vessel having a switchable oxygen source, such that the vessel can operate in aerobic or anaerobic conditions,
a phosphorus recovery solution storage vessel and carbon source fluidly connected to the first vessel, to provide a phosphorus recovery solution to the first vessel to cause release of phosphorus from the microorganisms into the phosphorus recovery solution during anaerobic operation of the first vessel.

13. The phosphorus removal system of claim 12, wherein
the first vessel has
a first inlet fluidly connected to a source of the water containing the phosphorus,
a second inlet fluidly connected to the phosphorus solution storage vessel,
a first outlet fluidly connected to the phosphorus recovery solution storage vessel, and
a second outlet fluidly connected to the filtration unit;
the phosphorus recovery solution storage vessel has
an inlet fluidly connected to the first outlet of the first vessel,
a first outlet fluidly connected to the first vessel via the second inlet of the first vessel and configured to recirculate the phosphorus recovery solution to the first vessel, and
a second outlet configured to remove the phosphorus recovery solution from the phosphorus recovery solution vessel; and
optionally, a filter configured to provide filter an effluent stream from the first vessel.

14. The phosphorus removal system of claim 12, wherein the first vessel comprises an agitator.

15. The phosphorus removal system of claim 12, further comprising a carbon source tank fluidly connected to the first vessel.

16. The phosphorus removal system of claim 12, comprising an aerator configured to provide aeration to the first vessel.

17. The phosphorus removal system of claim 12, further comprising a control unit.

18. The phosphorus removal system of claim 17, wherein the control unit is configured to monitor one or more of: water quality of the source of the water containing the phosphorus, the concentration of phosphorus in the first vessel, or the concentration of phosphorus in the phosphorus recovery solution, and further configured to adjust one or more of aeration of the first vessel, agitation of the first vessel, or a dose of the carbon the first vessel.

19. The phosphorus removal system of claim 12, wherein the biofilm is supported on a carrier.

20. The phosphorus removal system of claim 12, wherein the biofilm comprises bacteria.
